(19) United States
(12) Patent Application Publication
(10) Pub. No.: US 2012/0141327 A1
(43) Pub. Date: Jun. 7, 2012

(54) LABEL-FREE BIOSENSOR

(75) Inventors: Chul HUH, Daejeon (KR); Bong Kyu Kim, Daejeon (KR); Wan Joong Kim, Goyang (KR); Jong Cheol Hong, Daejeon (KR); Gun Yong Sung, Daejeon (KR)

(73) Assignee: Electronics and Telecommunications Research Institute, Daejeon (KR)

(21) Appl. No.: 13/283,477

(22) Filed: Oct. 27, 2011

(30) Foreign Application Priority Data
Dec. 3, 2010 (KR) 10-2010-0122974

(51) Int. Cl. G01N 21/75

(52) U.S. Cl. 422/69

(57) ABSTRACT

A label-free biosensor includes a substrate, a reaction inducing part for inducing a bio antigen-antibody reaction to occur, and a reaction detecting part formed on the substrate and adapted to measure current change in accordance with change in an amount of light, which is caused by the bio antigen-antibody reaction in the reaction inducing part, to detect a bio antigen.

### CROSS-REFERENCE TO RELATED APPLICATIONS

The present application claims priority to Korean patent application number 10-2010-0122974, filed on Dec. 3, 2010, which is incorporated by reference in its entirety.

### BACKGROUND OF THE INVENTION

The present invention relates to a biosensor, and more particularly, to a label-free biosensor for detecting a bio antigen quantitatively in accordance with an amount of light by a bio antigen-antibody reaction.

In general, a biosensor is a sensor that is composed of a bioreceptor and a signal transducer and may selectively sense a bio material to be analyzed.

Bioreceptors include enzymes that may selectively react with and bind to a specific bio material, proteins, receptors, cells, tissues, DNA, etc., and signal transducing methods employ various physical chemical methods, such as electrochemical, fluorescence, optics, color development, piezo-electricity, etc.

The applications of biosensors are very wide, ranging from medical areas such as early diagnosis of blood sugar, diabetes, cancers, etc. and sensors for monitoring, environmental areas such as measurements of phenol in waste water, heavy metals, agricultural chemicals, phosphides, and nitrogen compounds, and analyses of residual agricultural chemicals in food, antibiotics, and infectious pathogens to sensors for military, industrial, and research purposes.

Signal transducing modes conventionally used in sensing bio materials may be generally divided into electrochemical methods and optical methods.

Electrochemical methods are disadvantageous in that because a very weak signal from a bio material of a sample should be transduced into an electrical signal which may be measured by using devices such as an amplifier, etc. in order to sense the signal, the configuration of biosensors is complex and electronic devices to be used are expensive.

In addition, electrochemical methods have limitations in manufacturing biosensors which are excellent in selectivity and sensitivity because a body fluid including a bio material to be analyzed, for example, blood, urine, tears, etc. has numerous ions in a sample, which may affect electrical signals on a biosensor.

On the contrary, optical methods are those by which a signal from a bio material is transduced by using a light-emitting part and a light-receiving part to analyze the presence of the bio material, and are generally used in biosensors because the methods are advantageous in that the configuration of sensors is relatively simpler and signals are less affected by ions of a sample than in electrochemical methods.

In conventional optical methods for detecting a bio material, an optical biosensor is widely used, which usually labels antibodies with a fluorescent material, etc., and then detects the corresponding antigens to realize a amount of the antigen to be analyzed, which is proportional to the intensity of the fluorescence to be measured from the biosensor.

In addition, recently, research and development have been actively conducted on optical biosensors such as Surface Plasmon Biosensor, Waveguide Biosensor, etc., which does not use label materials such as fluorescent materials, for a label-free biosensor.

An optical biosensor is composed of an external light source and a light-detecting part for measuring light signals. Laser is used as a light-emitting device for generating light, and a spectrometer is used to detect light signals.

Laser used in optical biosensors is disadvantageous in that because it is generally produced by using compound semiconductor thin films, it is difficult to grow high quality compound semiconductor thin films on a substrate and the costs are high. In addition, because compound semiconductor thin films conventionally used in production of a light source are grown on a non-silicon based substrate, they have many difficulties, for example, the integration with silicon electronic devices for configuration of a circuit is not facilitated. Furthermore, since an optical biosensor is configured by using an external light source and a light-receiving part, a very complex optical system is required and as a result, there are many disadvantages in mass production and manufacture of inexpensive biosensors.

The technical configuration described above is provided to aid in understanding the present invention, and does not denote widely-known technology in the related art to which the present invention pertains.

### SUMMARY OF THE INVENTION

Embodiments of the present invention are directed to a label-free biosensor for detecting the change of an amount of light by a bio antigen-antibody reaction to detect the bio antigen-antibody reaction quantitatively.

In one embodiment, a label-free biosensor of the present invention includes: a substrate; a reaction inducing part for inducing a bio antigen-antibody reaction to occur; and a reaction detecting part formed on the substrate, and adapted to measure current change in accordance with change in an amount of light, which is caused by the bio antigen-antibody reaction in the reaction inducing part, to detect a bio antigen.

The substrate of the present invention may be a silicon substrate.

The reaction detecting part of the present invention may include a light-emitting part formed on the substrate, and adapted to emit light; an optical fiber for transmitting light incident from the light-emitting part; and a light-receiving part formed on the substrate, and adapted to receive light from the optical fiber to transduce the light into current.

The light emitting part of the present invention may be formed by stacking a hole injection layer for injecting holes; a light-emitting layer for coupling electrons with holes to emit light; and an electron injection layer for injecting the electrons into the light-emitting layer.

The electron injection layer of the present invention may be formed of a n-type silicon carbide-based or silicon carbon nitride-based thin film, the hole injection layer may be formed of a p-type silicon carbide-based or silicon carbon nitride-based thin film, and the light-emitting layer may be formed of silicon nitride (SiNₓ) including silicon nanocrystals.

The light-receiving part of the present invention may be formed by stacking a hole doping layer for doping holes; a photoelectric transducing layer for generating electrons and holes from light received from the light-emitting part; and an electron doping layer for doping the electrons.

The photoelectric transducing layer of the present invention may be formed of silicon nitride (SiNₓ) including silicon nanocrystals, the electron doping layer may be formed of a n-type silicon carbide-based or silicon carbon nitride-based thin film, and the hole doping layer may be formed of a p-type silicon carbide-based or silicon carbon nitride-based thin film.

The reaction inducing part of the present invention may include a photonic crystal adapted to have an amount of light changed by a bio antigen-antibody reaction by forming a bio antibody which reacts with and binds to a bio antigen of a fluid; and a microfluidic channel for inducing the fluid into the photonic crystal.

The photonic crystal of the present invention may protrude from the reaction detecting part in a nano-size to be periodically arranged, wherein the photonic crystal has a height of approximately 1 nm to approximately 1000 nm, a width of approximately 1 nm to approximately 1,000 nm, and a period of approximately 1 nm to approximately 10,000 nm.

The microfluidic channel of the present invention may be formed of silicon, an organic material, or polydimethylsiloxane (PDMS).

### BRIEF DESCRIPTION OF THE DRAWINGS

FIG. 1 illustrates a schematic view of a label-free biosensor according to one embodiment of the present invention.

FIG. 2 illustrates a schematic view of photonic crystals formed on the surface of the optical fiber in FIG. 1.

FIG. 3 illustrates a schematic view of a silicon nanocrystal light-emitting part, a light-receiving part, optical fibers, and nanocrystals in FIG. 1.

FIG. 4 illustrates a schematic view of nanocrystals and a microfluidic channel in FIG. 1.

FIG. 5 illustrates a method for detecting the label-free biosensor according to one embodiment of the present invention.

### DESCRIPTION OF SPECIFIC EMBODIMENTS

Hereinafter, LABEL-FREE BIOSENSOR in accordance with the present invention will be described in detail with reference to the accompanying drawings. In the drawings, the thicknesses of lines or the sizes of elements may be exaggeratedly illustrated for clarity and convenience of description. Moreover, the terms used henceforth have been defined in consideration of the functions of the present invention, and may be altered according to the intent of a user or operator, or conventional practice. Therefore, the terms should be defined on the basis of the entire content of this specification.

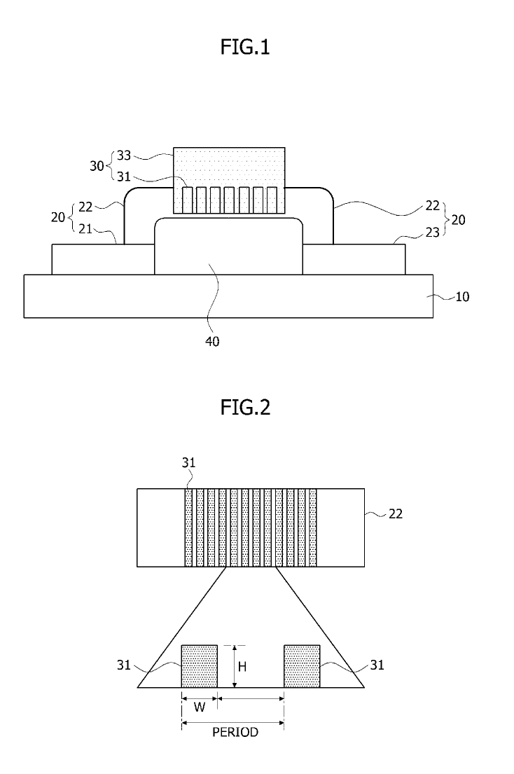

FIG. 1 illustrates a schematic view of a label-free biosensor according to one embodiment of the present invention.

The label-free biosensor according to one embodiment of the present invention includes a substrate 10, a reaction inducing part 30 for inducing a bio antigen-antibody reaction to occur, and a reaction detecting part 20 formed on the substrate 10, and adapted to detect a bio antigen using current change in accordance with change in an amount of light, which is caused by the bio antigen-antibody reaction in the reaction inducing part.

The substrate is a silicon substrate to allow for easy integration with silicon electronic devices. In addition, the silicon substrate is inexpensive and source gases required to form the reaction detecting part 20 on the silicon substrate are inexpensive. Therefore, the manufacturing costs of the label-free biosensor may be reduced.

An insulator 40 and the reaction detecting part 20 are formed on the substrate 10.

The reaction detecting part 20 includes a light-emitting part 21 for emitting light, an optical fiber 22 for transmitting light incident from the light-emitting part 21, and a light-receiving part 23 for receiving the light from the optical fiber 22 to transduce the light into current.

Herein, the light-emitting part 21 and the light-receiving part 23 are formed at both sides of the insulator 40 formed on the substrate 10, and the light-emitting part 21 is connected to the light-receiving part 23 through the optical fiber 22 on the insulator 40.

A reaction inducing part 30 to be described below is formed at the optical fiber 22, and an amount of light transmitted through the optical fiber 22 is changed in accordance with a bio antigen-antibody reaction occurring in the reaction inducing part 30. The change in the amount of light may be shown as the current change in the light-receiving part 23, and thus, a bio antigen may be detected.

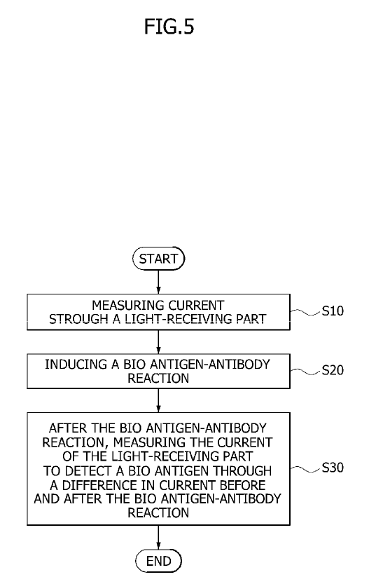

A bio antibody 32 (shown in FIG. 4) for binding to a bio antigen of a fluid is formed in the reaction inducing part 30, which includes a photonic crystal 31 for changing the amount of light by a bio antigen-antibody reaction and a microfluidic channel 33 for inducing a flow of the fluid into the photonic crystal to allow a bio antigen-antibody reaction to occur.

A plurality of photonic crystals 31 are formed on the surface of the optical fiber 22, protrude in nano-sizes, and are periodically arranged. A bio antigen 32 is formed on the photonic crystal 31, and formed between the phonic crystal 31 and the photonic crystal 31.

The microfluidic channel 33 is formed in order to include the photonic crystal 31 on the optical fiber 22. The microfluidic channel 33 induces the reaction of a bio material existing in a fluid, for example, a component such as blood, urine, tears, etc.

On the contrary, a bio antibody immobilized on the photonic crystal 31 and a bio antigen introduced through the microfluidic channel 33 bind to the bio antibody 32 formed on the photonic crystal 31 for reaction. At the time, an amount of light is changed in the photonic crystal 31, and thus the current transduced by the light-receiving part 23 becomes different before and after the bio antigen-antibody reaction.

In this way, light emitted from the light-emitting part 21 is detected as current in the light-receiving part 23, and when the difference in current measured before and after the bio antigen-antibody reaction occurs is analyzed, the presence of a desired bio material, that is, an antigen may be confirmed. The bio antigen also may be quantitatively analyzed.

FIG. 2 illustrates a schematic view of photonic crystals formed on the surface of the optical fiber in FIG. 1.

A plurality of the photonic crystals 31 are periodically arranged in nano-sizes on the surface of the optical fiber 22. The photonic crystal 31 is formed to have a height of approximately 1 nm to approximately 1,000 nm and a width of approximately 1 nm to approximately 1,000 nm. In addition, the photonic crystal 31 is formed to have a period of approximately 1 to approximately 10,000 nm therebetween.

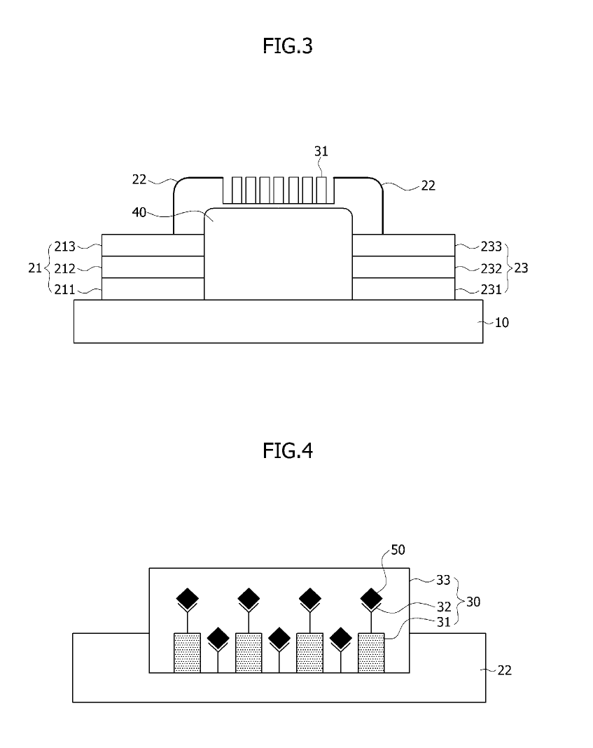

FIG. 3 illustrates a schematic view of a silicon nanocrystal light-emitting part, a light-receiving part, optical fibers, and nanocrystals in FIG. 1.

The light-emitting part 21, the light-receiving part 23, the optical fiber 22, and the photonic crystals 31 are formed on the substrate 10.

The substrate 10 is formed of silicon, and it is very easy for this silicon substrate to be integrated with other silicon electronic devices (not shown).

In addition, the silicon substrate 10 is inexpensive, and source gases, which are used for formation of various films formed on the substrate 10, are also inexpensive. Therefore, the manufacturing costs of a label-free biosensor may be greatly reduced.

For reference, although the formation of a silicon substrate is illustratively described herein, the technical scope of the present invention is not limited thereto and includes all the formations with various materials of which the light-emitting part 21 and the light-receiving part may be formed.

The light-emitting part 21 is formed by stacking a hole injection layer 211 formed on the substrate 10 and adapted to inject holes into a light-emitting layer 212, a light-emitting layer 212 formed on the hole injection layer 211 and adapted to connect an electron injection layer 213 to the hole injection layer 211 to emit light, and an electron injection layer 213 formed on the light-emitting part 212 and adapted to inject electrons.

The hole injection layer 211 is formed on the substrate 10. The hole injection layer 211 is formed of a p-type silicon film, for example, a p-type silicon carbide-based or silicon carbon nitride-based thin film.

The light-emitting layer 212 is formed on the hole injection layer 211. The light-emitting layer 212 is formed of a thin film including silicon nanocrystals. The light-emitting layer 212 is formed of a silicon nitride (SiNₓ) film including silicon nanocrystals.

The electron injection layer 213 is formed on the light-emitting layer 212. The electron injection layer 213 is formed of a n-type silicon film, for example, a n-type silicon carbide-based or silicon carbon nitride-based thin film.

In accordance with applied voltage, the light-emitting part 21 allows the injection of electrons and holes into the electron injection layer 213 and the hole injection layer 211, respectively, to emit light from the light-emitting layer 212.

The light-receiving part 23 is formed by stacking a hole doping layer 231 formed on the substrate 10 and adapted to dope holes separated from a photoelectric transducing layer 232, the photoelectric transducing layer 232 formed on the hole doping layer 231 and adapted to separate light received from the light-emitting part 21 into electrons and holes, and an electron doping layer 233 formed on the photoelectric transducing layer 232 and adapted to dope the electrons separated from the photoelectric transducing layer 232.

The hole doping layer 231 is formed on a silicon substrate 10. The hole doping layer 231 is formed of a p-type silicon film, for example, a p-type silicon carbide-based or silicon carbon nitride-based thin film.

The photoelectric transducing layer 232 is formed on the hole doping layer 231 to separate light received from the light-emitting part 21 into electrons and holes. The photoelectric transducing layer 232 is formed of a thin film layer including silicon nanocrystals. The photoelectric transducing layer 232 is formed of a silicon nitride (SiNₓ) film.

The electron doping layer 233 is formed on the photoelectric transducing layer 232. The electron doping layer 233 is formed of a n-type silicon film, for example, a n-type silicon carbide-based or silicon carbon nitride-based thin film.

The light-receiving part 23 allows the photoelectric transducing layer 232 to separate light received from the light-emitting part 21 into electrons and holes, and the separated electrons and holes are doped into the electron doping layer 233 and the hole doping layer 231 to be transduced into current.

The optical fiber 22 is connected to the light-emitting part 21 and the light-receiving part to be formed on an insulator 40 formed of silicon oxide (SiO₂). The optical fiber 22 is formed of a silicon nitride (SiNₓ) film.

When current is applied on the light-emitting part 21 and the light-receiving part 23 of a label-free biosensor according to the present invention through an external electrode, light emitted from the light-emitting part 21 is allowed to be incident into the optical fiber 22, and the light is detected in the light light-receiving part 23.

FIG. 4 illustrates a schematic view of nanocrystals and a microfluidic channel in FIG. 1.

The microfluidic channel 33 is formed on the photonic crystal 31 and the optical fiber 22. The microfluidic channel 33 is formed of silicon, an organic material, or polydimethylsiloxane (PDMS), etc.

Furthermore, as described above, the photonic crystal 31 is formed as a nano-size periodic structure, and a bio antibody 32 is formed between the photonic crystal 31 and the photonic crystal 31 by chemical, physical, or biological methods. The bio antibody 32 reacts with and binds to a bio antigen 50 introduced through the microfluidic channel.

The current of light incident through the photonic crystal 31 by reactions of the bio antibody 32 with the bio antigen 50 becomes different.

FIG. 5 illustrates a method for detecting the label-free biosensor according to one embodiment of the present invention.

First, a bio antibody 32 is formed on a photonic crystal 31 on the surface of an optical fiber 22, and voltage is applied on a light-emitting part 21 to allow light emitted from a light-emitting part 21 to be incident into the optical fiber 22. And then, current is measured through a light-receiving part 23 (S10).

At the time, the flow of a fluid, for example, blood, urine, tears, etc. is induced through a microfluidic channel 33 to lead to a bio antigen-antibody reaction (S20). Accordingly, a bio antibody formed on the photonic crystal 31 reacts with and binds to a bio antigen 50 of the fluid.

Accordingly, when light is received into the light-receiving part, the optical current measured in the light-receiving part 23 by a bio antigen-antibody reaction occurring in the photonic crystal 31 becomes different before and after the bio antigen-antibody reaction.

The bio antigen 50 to be analyzed may be quantitatively measured in accordance with this difference in current (S30).

The present invention may form optical fibers and photonic crystals on the same silicon substrate without any external light source and spectrometer to enhance the integration.

In addition, the present invention may detect bio molecules based on proteins, DNA, hormones, viruses, enzymes, etc. with low manufacturing costs.

Although embodiments of the present invention has been described with reference to drawings, these are merely illustrative, and those skilled in the art will understand that various modifications and equivalent other embodiments are possible. Consequently, the true technical protective scope of the present invention must be determined based on the technical spirit of the following claims.

What is claimed is:

1. A label-free biosensor, comprising:
a substrate;
a reaction inducing part for inducing a bio antigen-antibody reaction to occur; and
a reaction detecting part formed on the substrate, and adapted to measure current change in accordance with change in an amount of light, which is caused by the bio antigen-antibody reaction in the reaction inducing part, to detect a bio antigen.

2. The biosensor of claim 1, wherein the substrate is a silicon substrate.

3. The biosensor of claim 1, wherein the reaction detecting part comprises:
a light-emitting part formed on the substrate, and adapted to emit light;
an optical fiber for transmitting light incident from the light-emitting part; and
a light-receiving part formed on the substrate, and adapted to receive light from the optical fiber to transduce the light into current.

4. The biosensor of claim 3, wherein the light emitting part is formed by stacking a hole injection layer for injecting holes; a light-emitting layer for coupling electrons with holes to emit light; and an electron injection layer for injecting the electrons into the light-emitting layer.

5. The biosensor of claim 4, wherein the electron injection layer is formed of a n-type silicon carbide-based or silicon carbon nitride-based thin film, the hole injection layer is formed of a p-type silicon carbide-based or silicon carbon nitride-based thin film, and the light-emitting layer is formed of silicon nitride (SiNₖ) comprising silicon nanocrystals.

6. The biosensor of claim 3, wherein the light-receiving part is formed by stacking a hole doping layer for doping holes; a photoelectric transducing layer for generating electrons and holes from light received from the light-emitting part; and an electron doping layer for doping the electrons.

7. The biosensor of claim 6, wherein the photoelectric transducing layer is formed of silicon nitride (SiNₓ) comprising silicon nanocrystals, the electron doping layer is formed of a n-type silicon carbide-based or silicon carbon nitride-based thin film, and the hole doping layer is formed of a p-type silicon carbide-based or silicon carbon nitride-based thin film.

8. The biosensor of claim 1, wherein the reaction inducing part comprises:
photonic crystal adapted to have an amount of light changed by a bio antigen-antibody reaction by forming a bio antibody which reacts with and binds to a bio antigen of a fluid; and
a microfluidic channel for inducing a flow of the fluid into the photonic crystal.

9. The biosensor of claim 8, wherein the photonic crystal protrude from the reaction detecting part in a nano-size to be periodically arranged, and has a height of approximately 1 nm to approximately 1000 nm, a width of approximately 1 nm to approximately 1,000 nm, and a period of approximately 1 nm to approximately 10,000 nm.

10. The biosensor of claim 8, wherein the microfluidic channel is formed of silicon, an organic material, or polydimethylsiloxane (PDMS).
